(19) United States
(12) Patent Application Publication
(10) Pub. No.: US 2015/0333547 A1
(43) Pub. Date: Nov. 19, 2015

(54) BATTERY PROTECTION CIRCUIT PACKAGE

(71) Applicant: ITM SEMICONDUCTOR CO., LTD., Chungcheongbuk-do (KR)

(72) Inventors: Hyeok Hwi NA, Chungcheongbuk-do (KR); Ho Seok HWANG, Gyeonggi-do (KR); Young Seok KIM, Chungcheongbuk-do (KR); Sung Beom Park, Gyeonggi-do (KR); Sang Hoon AHN, Chungcheongbuk-do (KR); Hyun Suck Lee, Chungcheongbuk-do (KR); Sun Ho KIM, Gyeonggi-do (KR)

(21) Appl. No.: 14/713,131

(22) Filed: May 15, 2015

(30) Foreign Application Priority Data
May 15, 2014 (KR) 10-2014-0058434
Dec. 2, 2014 (KR) 10-2014-0174801
Dec. 8, 2014 (KR) 10-2014-0174905

(51) Int. Cl. H02J 7/00; H02H 7/18; H04W 4/00

(52) U.S. Cl. CPC H02J 7/0029; H04W 4/008; H02H 7/18; H02J 2007/0037; H02J 2007/0039; H02J 2007/004

(57) ABSTRACT

A battery protection circuit package is provided which is advantageous for integration and miniaturization. The battery protection circuit package includes: a substrate on which a conductive line pattern is disposed; a battery protection circuit element that is mounted on the substrate and includes a protection IC, a field effect transistor (FET), and at least one passive element; and an NFC antenna structure that is mounted on the substrate, and the conductive line pattern constitutes at least a part of an extension antenna that is connected to the NFC antenna structure to form a loop.

### BACKGROUND

1. Field

The present invention relates to a battery protection circuit package and, more particularly, to a battery protection circuit package which can be decreased in size and simplified in processes. The present invention also relates to a battery protection circuit package which can increase an area of an antenna to improve antenna performance.

2. Description of Related Technology

Wireless short-range communication or near field communication (NFC) is a noncontact wireless short-range communication standard which enables wireless communication between electronic devices with low power in a short distance of 10 cm or less using a frequency of 13.56 MHz, and is developed in cooperation by NXP Semiconductor of Holland and Sony of Japan in 2002. Transfer rates of the NFC include, for example, 106 Kbps, 212 Kbps, 424 Kbps, and 848 Kbps. The NFC is excellent in security due to proximity and encryption technology and can make recognition between devices without using a complicated pairing procedure of allowing recognition between devices. Particularly, the NFC is smartcard type noncontact wireless short-range communication technology using RFID techniques and has features of bidirectionality, relatively-large memory space, relative-wide applicable service, and the like. Accordingly, electronic devices such as smart phones and tablet PCs which have been recently commercialized employ the NFC.

On the other hand, a battery is used for portable terminals such as smart phones and tablet PCs. A lithium ion battery is a battery which is most widely used for portable terminals, but generates heat with overcharge and overcurrent and has a performance degradation and a risk of explosion when heat is continuously generated and a temperature rises. Accordingly, a protection circuit unit that senses and intercepts overcharge, overdischarge, and overcurrent is generally mounted on a battery, or a protection circuit structure that senses overcharge, overdischarge, and overcurrent and shuts down a battery is installed outside the battery.

Recently, products in which an NFC antenna structure is incorporated into a battery of a portable terminal have come to the market. In this case, there are problems in that manufacturing costs thereof increase because a process of coupling the NFC antenna structure to the battery is additionally required, and the size of a battery increases for the purpose other than charging because an additional pad for the coupling process is required.

### SUMMARY OF THE INVENTION

The present invention is made to solve various problems including the above-mentioned problems and an object thereof is to provide a battery protection circuit package which can achieve a decrease in size and increase an area of an antenna to improve antenna performance. This object is illustrative and the scope of the present invention is not limited to the object.

According to an aspect of the present invention, there is provided a battery protection circuit package. The battery protection circuit package is a package that is electrically connected to electrode terminals of a battery bare cell, and includes: a substrate on which a conductive line pattern is disposed; a battery protection circuit element that is mounted on the substrate and includes a protection IC, a field effect transistor (FET), and at least one passive element; and an NFC antenna structure that is mounted on the substrate, wherein the conductive line pattern constitutes at least part of an extension antenna that is connected to the NFC antenna structure to form a loop.

In the battery protection circuit package, the NFC antenna structure may have a form of a chip.

In the battery protection circuit package, the substrate may include a printed circuit board (PCB), the conductive line pattern may be a pattern on the printed circuit board, both ends of the conductive line pattern may be respectively connected to the NFC antenna structure, and the extension antenna may include only the conductive line pattern.

In the battery protection circuit package, the conductive line pattern may surround an edge of the printed circuit board.

In the battery protection circuit package, the substrate may include a lead frame including a plurality of leads and a printed circuit board (PCB) disposed on the lead frame, the lead frame may include a first internal connection terminal lead and a second internal connection terminal lead that are disposed on both edges of the lead frame, respectively, and are electrically connected to electrode terminals of the battery bare cell; an external connection terminal lead that is disposed between the first internal connection terminal lead and the second internal connection terminal lead and constitutes a plurality of external connection terminals; and a dummy lead that is disposed between the first internal connection terminal lead and the second internal connection terminal lead and constitutes part of the loop, the conductive line pattern may be disposed on the printed circuit board, both ends of the conductive line pattern and both ends of the dummy lead may be connected to each other via an electrical connection member, and the extension antenna may include the conductive line pattern, the dummy lead, and the electrical connection member.

In the battery protection circuit package, the printed circuit board may be disposed on the external connection terminal lead so as not to overlap the dummy lead.

The battery protection circuit package may further include a sealing member that seals at least one selected from a group consisting of at least part of the substrate, the battery protection circuit element, the NFC antenna structure, and the conductive line pattern.

In the battery protection circuit package, the length of the extension antenna may be set such that a ratio of an inductance value generated in the extension antenna and an inductance value generated in the NFC antenna structure is equal to or greater than 13%.

According to another aspect of the present invention, there is provided a battery protection circuit package. The battery protection circuit package is a package that is electrically connected to electrode terminals of a battery bare cell, and includes: a substrate; a battery protection circuit element that is mounted on the substrate and includes a protection IC, a field effect transistor (FET), and at least one passive element; a first sealing member that is disposed on the substrate; and an NFC antenna that surrounds at least part of the outer circumferential surface of the first sealing member.

At least part of the NFC antenna may be disposed in a groove in at least part of the outer circumferential surface of the first sealing member.

The NFC antenna may surround the outer circumferential surface of the first sealing member by one or more turns.

The battery protection circuit package may further include an antenna structure that is mounted on the substrate, sealed by the first sealing member and used for NFC communication, and the NFC antenna may be connected to the antenna structure.

The antenna structure may have a form of a chip.

The substrate may be a lead frame including a plurality of leads, the plurality of leads may include a first internal connection terminal lead and a second internal connection terminal lead that are disposed on both edges of the lead frame, respectively, and are electrically connected to electrode terminals of the battery bare cell; and an external connection terminal lead that is disposed between the first internal connection terminal lead and the second internal connection terminal lead and constitutes a plurality of external connection terminals, and a battery protection circuit may be constituted without using a printed circuit board by being provided with an electrical connection member that electrically connects two selected from a group consisting of the antenna structure, the protection IC, the field effect transistor, and the plurality of leads.

The NFC antenna and the antenna structure may be connected to each other via part of portions that are not sealed by the first sealing member among the plurality of leads.

The length of the NFC antenna may be set such that a ratio of an inductance value generated in the NFC antenna and an inductance value generated in the antenna structure is equal to or greater than 13%.

The battery protection circuit package may further include a second sealing member that seals the NFC antenna surrounding at least part of the outer circumferential surface of the first sealing member.

The first sealing member may seal at least part of the substrate and/or the battery protection circuit element.

According to some embodiments of the present invention having the above-mentioned configurations, it is possible to provide a battery protection circuit package having an NFC antenna which is advantageous for integration and miniaturization and which can improve performance of an antenna. The scope of the present invention is not limited to these advantages.

### BRIEF DESCRIPTION OF THE DRAWINGS

FIG. 1A is a circuit diagram illustrating a battery protection circuit that is realized in a part of a battery protection circuit package according to a comparative example of the present invention.

FIG. 1B is a diagram illustrating a configuration of general near field communication (NFC).

FIG. 2 is an exploded perspective view illustrating a battery pack including the battery protection circuit package according to the comparative example of the present invention.

FIG. 3 is a perspective view illustrating the battery protection circuit package according to the comparative example of the present invention.

FIG. 4 is a coupled perspective view illustrating the battery pack including the battery protection circuit package according to the comparative example of the present invention.

FIG. 5 is an exploded perspective view illustrating a battery pack including a battery protection circuit package according to an embodiment of the present invention.

FIGS. 6A and 6B are perspective views illustrating the battery protection circuit package according to the embodiment of the present invention.

FIG. 7 is a perspective view illustrating a configuration of the battery protection circuit package according to the embodiment of the present invention in a state in which a sealing member is not formed.

FIGS. 8A to 8C are perspective views illustrating a configuration of a battery protection circuit package according to another embodiment of the present invention in a state in which a sealing member is not formed.

FIGS. 9A to 9C are perspective views schematically illustrating a configuration of an NFC antenna which is formed in a battery protection circuit package according to still another embodiment of the present invention.

FIGS. 10A to 10C are perspective views illustrating a partial configuration of a battery protection circuit package according to still another embodiment of the present invention.

FIGS. 11A and 11B are perspective views schematically illustrating a configuration of a battery pack including a battery protection circuit package according to still another embodiment of the present invention.

### DETAILED DESCRIPTION

Hereinafter, various embodiments of the present invention will be described in detail with reference to the accompanying drawings.

Embodiments of the present invention are provided to further completely explain the present invention to those skilled in the art, the following embodiments can be modified in various forms, and the scope of the present invention is not limited to the embodiments. The embodiments are provided to make this disclosure more faithful and complete and to completely transmit the idea of the present invention to those skilled in the art. Thicknesses or magnitudes of layers in the drawings are exaggerated for the purpose of convenience and clarity of explanation.

In the whole specification, when it is mentioned that one element such as a film, an area, or a substrate is located “on”, “to be connected to”, “to be stacked on”, or “to be coupled to” another element, it can be analyzed that one element is located directly “on”, “to be connected to”, “to be stacked on”, or “to be coupled to” another element or that still another element is interposed therebetween. On the other hand, when it is mentioned that one element such as a film, an area, or a substrate is located “directly on”, “to be connected directly to”, “to be stacked directly on”, or “to be coupled directly to” another element, it can be analyzed that still another element is not interposed therebetween. Like elements will be referenced by like reference numerals. Term “and/or” used in this specification includes any one of arranged items or all combinations of one or more thereof.

In this specification, terms such as “first” and “second” are used to describe various members, components, areas, layers, and/or portions, but the members, components, areas, layers, and/or portions should not be limited to the terms. These terms are used for merely distinguishing one member, component, area, layer, or portion from another member, component, area, layer, or portion. Therefore, a first member, component, area, layer, or portion can denotes a second member, component, area, layer, or portion without departing from the teaching of the present invention.

Relative terms such as “on” or “above” and “under” or “below” can be used herein to describe positional relationships between one element and another element as illustrated in the drawings. The relative terminals can be understood to include other directions of an element in addition to the directions illustrated in the drawings. For example, if an element is turned over in the drawings, an element illustrated to be present on a top surface of another element has a direction on the bottom surface of another element. Accordingly, the term “on” may include all directions of “under” and “on” depending on a specific direction of the drawing. When an element faces another direction (rotates by 90 degrees with respect to another direction), the relative positions or directions used in this specification can be analyzed accordingly.

Terms used in this specification are for explaining specific embodiments and are not for limiting the present invention. In this specification, a singular number may include a plural number unless differently mentioned in the context. Terms “comprise” and/or “comprising” used in this specification specify presence of mentioned shapes, numbers, steps, operations, members, elements, and/or groups thereof, but does not exclude presence or addition of one or more other shapes, numbers, steps, operations, members, elements, and/or groups thereof.

Embodiments of the present invention will be described below with reference to the accompanying drawings schematically illustrating embodiments of the present invention. In the drawings, modifications of the illustrated shapes can be predicted, for example, depending on manufacturing techniques and/or tolerances. Therefore, the embodiments of the present invention should not be analyzed to be limited to a specific shape illustrated in this specification and to include, for example, a variation in shape which is caused in manufacturing.

In embodiments of the present invention, a lead frame has a configuration in which lead terminals are patterned in a metal frame and is distinguished from a printed circuit board in which metal wiring layers are formed on an insulating core in terms of structure, thickness, and the like.

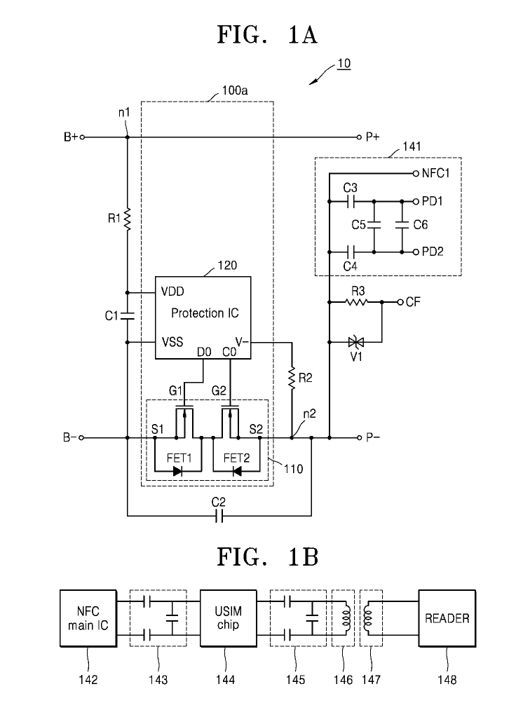

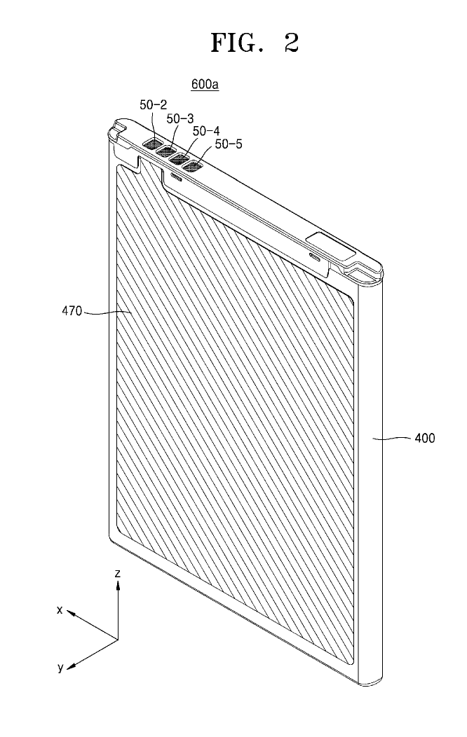

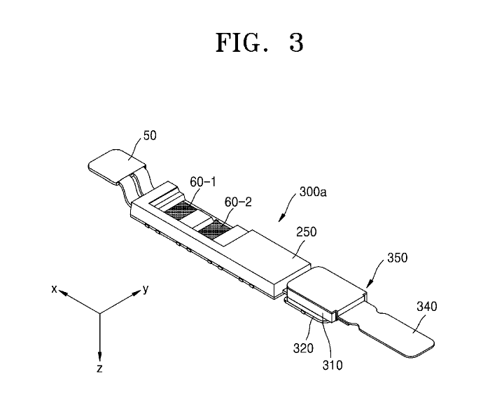

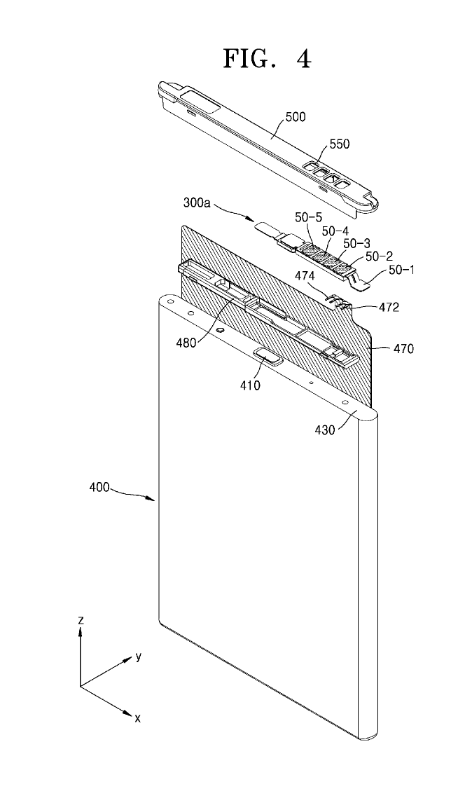

FIG. 1A is a circuit diagram illustrating a battery protection circuit which is realized in a part of a battery protection circuit package according to a comparative example of the present invention. FIG. 1B is a diagram illustrating a configuration of general near field communication (NFC). FIG. 2 is an exploded perspective view illustrating a battery pack including the battery protection circuit package according to the comparative example of the present invention. FIG. 3 is a perspective view illustrating the battery protection circuit package according to the comparative example of the present invention. FIG. 4 is a coupled perspective view illustrating the battery pack including the battery protection circuit package according to the comparative example of the present invention.

A battery protection circuit which is embodied as a part of a battery protection circuit package according to an embodiment of the present invention may have the same configuration as the battery protection circuit according to the comparative example of the present invention illustrated in FIG. 1A, except that NFC connection terminals PD1 and PD2 are excluded.

Referring to FIG. 1A, a battery protection circuit 10 includes first and second internal connection terminals B+ and B− for connection to a battery cell and first to third external connection terminals P+, CF, and P− for connection to an electronic device (for example, a portable terminal) which is connected to a charger at the time of charging and which operates with a battery as a power source at the time of discharging. Among the first to third external connection terminals P+, CF, and P−, the first external connection terminal P+ and the third external connection terminal P− are used for supply of power, and the second external connection terminal CF is used, for example, to charge the battery to correspond to the battery. The second external connection terminal CF may be connected to a thermistor which senses a battery temperature at the time of charging and may be used as a terminal for various functions.

The battery protection circuit 10 has a structure in which a dual FET chip 110, a protection integrated circuit (protection IC) 120, resistors R1, R2, and R3, a varistor V1, and capacitors C1 and C2 are connected. The dual FET chip 110 includes a first field effect transistor FET1 and a second field effect transistor FET2 which have a common drain structure. The protection IC 120 includes a terminal (VDD terminal) which is connected to the first internal connection terminal B+ as a + terminal of the battery via the resistor R1, to which a charging voltage or a discharging voltage is applied via a first node n1, and which is used to sense the supply of a voltage and the battery voltage, a reference terminal (VSS terminal) which serves as a reference for an operation voltage in the protection IC 110, a sensing terminal (V− terminal) which is used to sense a charging or discharging state and an overcurrent state, a discharge cutoff signal output terminal (D0 terminal) which is used to turn off the first field effect transistor FET1 in an overdischarged state, and a charge cutoff signal output terminal (C0 terminal) which is used to turn off the second field effect transistor FET2 in an overcharged state.

The protection IC 120 includes a reference voltage setting unit, a comparison unit which compares a reference voltage with a charging or discharging voltage, an overcurrent detecting unit, and a charging and discharging detecting unit. A criterion for determining the charged state and the discharged state can be changed depending on specifications requested by a user, and the charged or discharged state is determined by recognizing a voltage difference between the terminals of the protection IC 120 based on the determined criterion.

The protection IC 120 is configured to switch the D0 terminal to a low level to turn off the first field effect transistor FET1 in an overdischarged state due to continuous discharging and to switch the C0 terminal to a low level to turn off the second field effect transistor FET2 in an overcharged state due to continuous charging. The protection IC 120 is configured to turn off the second field effect transistor FET2 at the time of charging and to turn off the first field effect transistor FET1 at the time of discharging when an overcurrent flow.

The resistor R1 and the capacitor C1 serve to stabilize a variation in source voltage of the protection IC 120. The resistor R1 is connected between the first node n1 which is a supply node of a source voltage V1 of the battery and the VDD terminal of the protection IC 120. The capacitor C1 is connected between the VDD terminal and the VSS terminal of the protection IC 120. Here, the first node n1 is connected to the first internal connection terminal B+ and the first external connection terminal P+. Since an increase in resistance of the resistor R1 causes an increase in detected voltage due to a current flowing in the protection IC 120 at the time of detecting a voltage, the resistance value of the resistor R1 is set to an appropriate value of 1 kΩ or less. For the purpose of stable operation, the capacitance value of the capacitor C1 is set to an appropriate value of 0.01 μF or more.

The resistor R1 and the resistor R2 serve as a current-limiting resistor when a high-voltage charger exceeding the maximum rated voltage of the protection IC 120 is connected or a charger is reversely connected. The resistor R2 is connected between the V− terminal of the protection IC 120 and the second node n2 connected to the source terminal S2 of the second field effect transistor FET2. Since the resistor R1 and the resistor R2 causes power consumption, the total resistance value of the resistor R1 and the resistor 2 is generally set to be greater than 1 kΩ. When the resistance value of the resistor R2 is excessively great, restoration may not be caused after the overcharging is cut off. Accordingly, the resistance value of the resistor R2 is set to be equal to or less than 10 kΩ.

The capacitor C2 is connected between the second node n2 (or the third external connection terminal P−) and the source terminal S1 (or the VSS terminal or the second internal connection terminal B−) of the first field effect transistor FET1. The capacitor C2 does not have a great influence on characteristics of products including the battery protection circuit, but is added in response to a user's request or for the purpose of stability. The capacitor C2 serves to improve resistance to voltage variation or external noise to stabilize a system.

The resistor R3 and the varistor V1 are elements for electrostatic discharge protection and surge protection and are connected in parallel between the second external connection terminal CF and the second node n2 (or the third external connection terminal P1). The varistor V1 is an element of which resistance decreases when an overvoltage is generated. When an overvoltage is generated, the resistance of the varistor decreases to minimize circuit damage due to the overvoltage.

On the other hand, an NFC circuit 141 may be added to the above-mentioned configuration of the battery protection circuit to support near field communication (NFC). The added NFC circuit 141 includes, for example, an NFC external connection terminal NFC1, NFC connection terminals PD1 and PD2, and NFC matching elements C3, C4, C5, and C6. The NFC connection terminals PD1 and PD2 illustrated in FIG. 1A are embodied by terminals 60-1 and 60-2 in a package 300a illustrated in FIG. 3, and can come in contact with ends 472 and 474 (FIG. 4) of an NFC antenna 470 (FIG. 4) disposed around a battery pack 600a. The NFC antenna 470 may be, for example, a loop-shaped antenna. When the ends 472 and 474 of the an NFC antenna 470 come in contact with the NFC connection terminals PD1 and PD2, the NFC matching elements C3, C4, C5, and C6 and the NFC antenna 470 are electrically connected to form a closed loop. The NFC matching elements C3, C4, C5, and C6 may be, for example, frequency-matching capacitors. For example, when both ends 472 and 474 of the NFC antenna 470 are connected to the capacitors which are the NFC matching elements to form a closed loop, an NFC frequency region of 13.5 MHz can be generated to communicate with an NFC device using resonance which occurs in the NFC antenna 470 and the capacitors C3, C4, C5, and C6.

Referring to FIG. 1B, an exemplary configuration for general near field communication (NFC) includes an NFC control integrated circuit (IC) unit 142, a USIM chip 144, and a reader 148. A first inductor 146 and a second inductor 147 are disposed between the USIM chip 144 and the reader 148, and a first capacitor unit 145 is disposed between the USIM chip 144 and the first inductor 146. A second capacitor unit 143 is disposed between the NFC control IC unit 142 and the USIM chip 144.

The NFC antenna 470 corresponds to the first inductor 146 illustrated in FIG. 1B, and the capacitors C3, C4, C5, and C6 correspond to the first capacitor unit 145 illustrated in FIG. 1B. The first inductor 146 and the first capacitor unit 145 are connected to the NFC control IC unit 142, the second capacitor unit 143, and the USIM chip 144 via the NFC external connection terminal NFC1.

Referring to FIGS. 2 to 4, in the battery protection circuit package and the battery pack according to the comparative example of the present invention, the NFC antenna 470 is disposed on a side surface of a battery bare cell 400 constituting the battery pack 600a. The ends 472 and 474 of the NFC antenna 470 can be bonded to terminal pads 60-1 and 60-2 of the battery protection circuit package 300a, for example, using a soldering process. However, since the battery protection circuit package 300a requires the configuration of the terminal pads 60-1 and 60-2 for the antenna soldering process, the battery protection circuit package 300a is disadvantageous for miniaturization and has a limit in guaranteeing an inner space of the package. In addition, there is a problem in that the process of manufacturing the battery pack is complicated due to the antenna soldering process. The bonding part between the NFC antenna 470 and the battery protection circuit package 300a may be weak in structure and shearing strength thereof may be low in terms of a whole structure.

Battery protection circuit packages according to embodiments of the present invention solve the above-mentioned problems by being provided with an antenna structure including an NFC antenna, and complement a recognition range of an antenna by being additionally provided with an extension antenna, which will be described below.

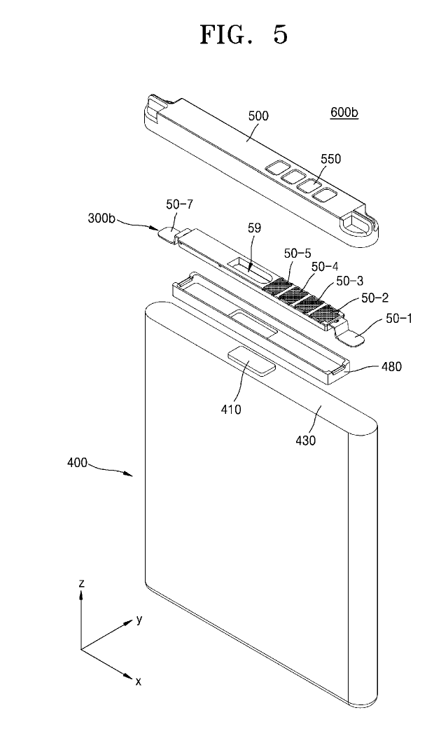

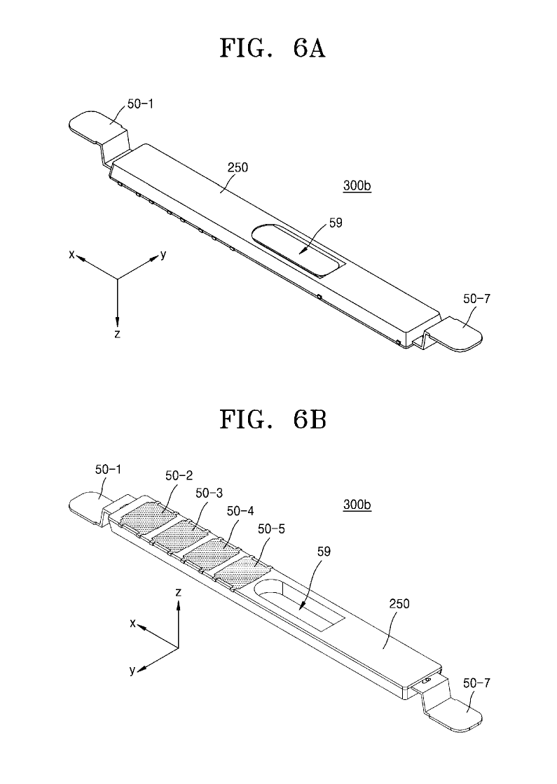

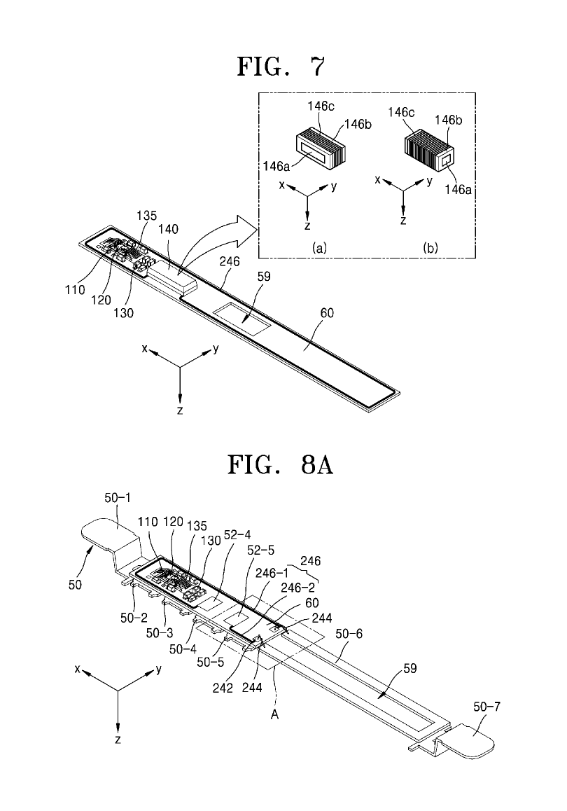

FIG. 5 is an exploded perspective view illustrating a battery pack including a battery protection circuit package according to an embodiment of the present invention. FIGS. 6A and 6B are perspective views illustrating the battery protection circuit package according to the embodiment of the present invention. FIG. 7 is a perspective view illustrating a configuration of the battery protection circuit package according to the embodiment of the present invention in a state in which a sealing member is not formed.

Referring to FIGS. 5, 6A, 6B, and 7, a battery protection circuit package 300b according to an embodiment of the present invention is a package which can be electrically connected to electrode terminals 410 and 430 of a battery bare cell 400 and includes a substrate 60 on which a conductive line pattern 246 is formed, battery protection circuit elements which are mounted on the substrate 60 and which include a protection IC 120, a field effect transistor (FET) 110, and at least one passive element 130, and an NFC antenna structure 140 which is mounted on the substrate 60.

The substrate 60 includes a printed circuit board (PCB). The battery protection circuit elements including the protection IC 120, the field effect transistor (FET) 110, and at least one passive element 130 are directly mounted on the substrate 60 constituted by the printed circuit board.

In the structure illustrated in FIG. 7, the battery protection circuit package 300b illustrated in FIGS. 5, 6A, and 6B can be embodied by disposing leads 50-1 and 50-7 at both ends of the substrate 60 and then forming a sealing member 250 which seals at least one of at least part of the substrate 60, the battery protection circuit elements 110, 120, and 130, the NFC antenna structure 140, and the conductive line pattern 246.

Both ends of the substrate 60 can be bonded to the leads 50-1 and 50-7 which can be electrically connected to the battery bare cell. In this case, external connection terminals 50-2, 50-3, 50-4, and 50-5 may be conductive pads formed on the other surface of the substrate. The other surface of the substrate is a surface opposite to the surface of the substrate on which the battery protection circuit elements 110, 120, and 130 are mounted.

The conductive line pattern 246 may constitute at least part of an extension antenna which is connected to the NFC antenna structure 140 to form a loop. Here, the loop has an arbitrary shape which can generate inductance. The loop is not limited to a closed loop.

Both ends of the conductive line pattern 246 may be connected to the NFC antenna structure 140. According to an embodiment, the extension antenna may include only the conductive line pattern 246. The conductive line pattern 246 is a pattern formed on the printed circuit board, and is not a wiring pattern for electrical connection of the protection IC 120, the field effect transistor (FET) 110, and at least one passive element 130, but may be a pattern which is formed particularly formed to constitute at least a part of the first inductor 146 illustrated in FIG. 1B. The conductive line pattern 246 may be a pattern which surrounds the edge of the printed circuit board.

On the other hand, the NFC antenna structure 140 may have, for example, a form of a chip. The NFC antenna structure 140 connected to the conductive line pattern 246 will be described below.

The NFC antenna structure 140 may include an inductor which can resonate at an NFC frequency region. The inductor of the NFC antenna structure 140 corresponds to at least a part of the first inductor 146 illustrated in FIG. 1B and can be replaced for the NFC antenna 470 illustrated in FIG. 2.

According to modified examples of the present invention, the NFC antenna structure 140 may include the first inductor 146 illustrated in FIG. 1B and may further include at least one of the first capacitor unit 145, the second capacitor unit 143, and the NFC control IC unit 142.

In the battery protection circuit package 300b according to some embodiments of the present invention, since the terminal pads 60-1 and 60-2 (FIG. 3) for the antenna soldering process are not necessary, it is possible to decrease the size of the package and to guarantee the internal space of the package. It is possible to exclude the antenna soldering process and thus to simplify the process of manufacturing a battery pack. In addition, it is possible to improve shearing strength in terms of the whole structure by mounting and sealing the NFC antenna in the form of a chip in the battery protection circuit package without disposing and bonding a film-shaped NFC antenna outside the battery protection circuit package.

The NFC antenna structure 140 including the inductor which can resonate in the NFC frequency region may have various winding structure.

First, a winding structure illustrated in (a) of FIG. 7 includes a coil having a first winding direction. For example, the winding structure includes a core 146a formed of a nickel-ferrite material and a coil 146c having the first winding direction and being wound in a direction parallel to an x axis direction and a z axis direction so as to surround a bobbin 146b. In this case, a direction of an induced magnetic field generated in cooperation with the NFC reader 148 is parallel to a y axis direction. That is, when the side surfaces of the battery bare cell 400 include a large-width surface (surface perpendicular to they axis) and a small-width surface (surface perpendicular to the x axis), the direction of the magnetic field induced in the antenna structure 140 including the inductor may be perpendicular to the large-width surface of the battery bare cell 400. In this winding structure, near field communication can be realized when the NFC reader and the large-width surface of the battery bare cell 400 are located to be parallel to each other.

Second, in the battery protection circuit package, plural NFC antenna structures 140 having a winding structure illustrated in (b) of FIG. 7 may be arranged to be separated from each other. When the NFC antenna structure 140 has the form of a chip, the battery protection circuit package may include plural chips including an NFC antenna. Each winding structure is the same as described in the first example. That is, each NFC antenna structure 140 includes a coil 146c having the first winding direction as illustrated in (b) of FIG. 7, and the direction of the magnetic field induced in the NFC antenna structures 140 may be perpendicular to a large-width surface of the battery bare cell 400 when the side surfaces of the battery bare cell 400 include a large-width surface (surface perpendicular to the y axis) and a small-width surface (surface perpendicular to the x axis). On the other hand, in a modified example, when the NFC antenna structure 140 has the form of a chip, the battery protection circuit package may include a single chip and plural winding structures illustrated in (b) of FIG. 7 may be disposed in the single chip. In this winding structure, near field communication can be realized when the NFC reader and the large-width surface of the battery bare cell 400 are located to be parallel to each other. It can be expected to improve sensitivity of near field communication in comparison with the antenna structure 140 of the first example.

Third, the battery protection circuit package includes plural antenna structures 140 which are separated from each other, and some antenna structures of the plural antenna structures include the coil 146c having the first winding direction as illustrated in (a) of FIG. 7 and the other antenna structures include a coil 146c having a second winding direction which is perpendicular to the first winding direction as illustrated in (b) of FIG. 7. For example, the winding structure having the first winding direction includes a core 146a formed of a nickel-ferrite material and a coil 146c wound in a direction parallel to the x axis direction and the z axis direction so as to surround a bobbin 146b. The winding structure having the second winding direction includes a core 146a formed of a nickel-ferrite material and a coil 146c wound in a direction parallel to they axis direction and the z axis direction so as to surround a bobbin 146b. When the side surfaces of the battery bare cell 400 include the large-width surface (surface perpendicular to they axis) and the small-width surface (surface perpendicular to the x axis), the direction of a magnetic field induced in the coil having the first winding direction may be perpendicular to the large-width surface of the battery bare cell 400 and the direction of a magnetic field induced in the coil having the second winding direction may be perpendicular to the small-width surface of the battery bare cell 400.

When the antenna structure 140 has the form of a chip, the battery protection circuit package may include a first antenna structure in the form of a chip having the winding structure of the first winding direction and a second antenna structure in the form of a chip having the winding structure of the second winding direction. In another example, the battery protection circuit package may include a winding structure including the coil 146c having the first winding direction and the winding structure including the coil 146c having the second winding direction in a single chip. In this winding structure, even when the NFC reader and the large-width surface of the battery bare cell 400 are not located to be relatively parallel to each other but form an arbitrary angle, near field communication can be realized. It can be expected to improve sensitivity of near field communication.

On the other hand, the winding structure constituting the antenna structure 140 is described to be a winding structure in which a coil is wound on a core. However, the NFC antenna structure 140 according to the technical idea of the present invention is not limited to this winding structure and may be embodied, for example, by patterning a conductive material.

Since the NFC antenna structure 140 illustrated in FIG. 7 has a size smaller than the NFC antenna 470 illustrated in FIG. 4, the antenna strength may be relatively small. The conductive line pattern 246 connected to the NFC antenna structure 140 to compensate for the strength may be an extension antenna or an auxiliary antenna of the NFC antenna structure 140.

The conductive line pattern 246 illustrated in FIG. 7 may have a shape which can generate inductance and may have, for example, a shape of at least part of a loop which can generate inductance. Inductance is a quantity indicating a ratio of a counter-electromotive force generated by electromagnetic induction due to a variation in a current flowing in a circuit and the unit thereof is H (Henry).

The inventor of the present invention found that the inductance value generated in the conductive line pattern 246 should be greater by a predetermined proportion than the inductance value generated in the NFC antenna structure 140 in order for the conductive line pattern 246 not to merely be a conductive pattern but to actually serve as an auxiliary antenna.

Table 1 describes results of experiments for checking whether the conductive line pattern 246 serve as an NFC auxiliary antenna depending on the inductance value generated in the conductive line pattern 246 when the inductance value generated in the NFC antenna structure 140 is 0.56 μH.

TABLE 1

| | Inductance value | Length of | | |
|---|---|---|---|---|
| | of extension | extension | | Serving as |
| Experimental | antenna | antenna | Inductance | NFC auxiliary |
| Example | (μH) | (mm) | ratio | antenna |
| Ex. 1 | 0.04 | 34 | 6% | x |
| Ex. 2 | 0.05 | 37 | 8% | x |
| Ex. 3 | 0.07 | 43 | 11% | x |
| Ex. 4 | 0.08 | 47 | 13% | ∘ |
| Ex. 5 | 0.09 | 50 | 14% | ∘ |

In Experimental Example 1, when the length of the conductive line pattern 246 forming a loop was 34 mm, the inductance value generated in the conductive line pattern 246 was 0.04 μH and the conductive line pattern 246 did not serve as the NFC auxiliary antenna. That is, when the inductance value generated in the conductive line pattern 246 was 6% of the inductance value generated in the NFC antenna structure 140, improvement in NFC recognition distance was not observed in spite of introduction of the extension antenna including the conductive line pattern 246.

On the contrary, in Experimental Example 4, when the length of the conductive line pattern 246 forming a loop was 47 mm, the inductance value generated in the conductive line pattern 246 was 0.08 μH and the conductive line pattern 246 served as the NFC auxiliary antenna. That is, when the inductance value generated in the conductive line pattern 246 was 13% of the inductance value generated in the NFC antenna structure 140, improvement in NFC recognition distance was observed due to the introduction of the extension antenna including the conductive line pattern 246.

On the contrary, in Experimental Example 4, when the length of the conductive line pattern 246 forming a loop was 47 mm, the inductance value generated in the conductive line pattern 246 was 0.08 μH and the conductive line pattern 246 served as the NFC auxiliary antenna. That is, when the inductance value generated in the conductive line pattern 246 was 13% of the inductance value generated in the NFC antenna structure 140, improvement in NFC recognition distance was observed due to the introduction of the extension antenna including the conductive line pattern 246.

Referring to Experimental Examples 1 to 5, it can be seen that when the ratio of the inductance value generated in the conductive line pattern 246 and the inductance value generated in the NFC antenna structure 140 is equal to or greater than a predetermined ratio (for example, 13%) by guaranteeing the length of the conductive line pattern 246 constituting the extension antenna to be equal to or greater than a predetermined length, improvement in NFC recognition distance can be observed due to introduction of the extension antenna including the conductive line pattern 246.

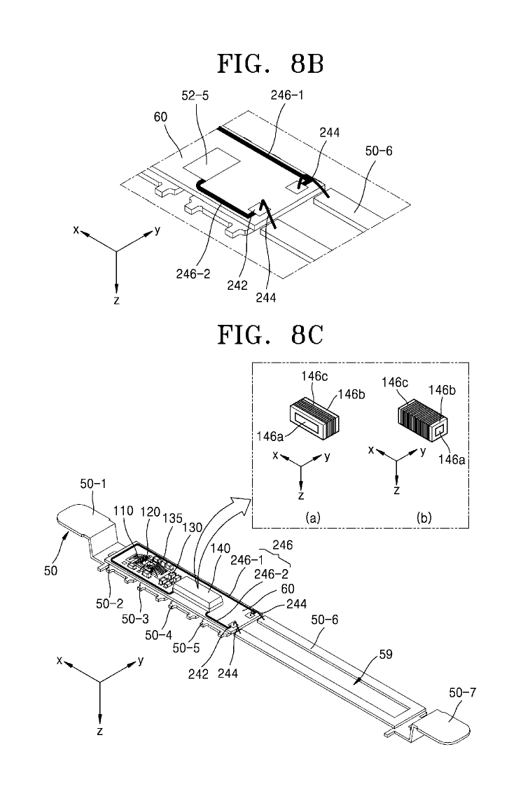

FIG. 8A is a perspective view illustrating a configuration of a battery protection circuit package according to another embodiment of the present invention in a state in which a sealing member is not formed, FIG. 8B is an enlarged perspective view illustrating part A in the structure illustrated in FIG. 8A, and FIG. 8C is a perspective view illustrating a configuration in which the NFC antenna structure 140 is mounted on the structure illustrated in FIG. 8A.

Referring to FIGS. 5, 6A, and 6B and FIGS. 8A to 8C, a battery protection circuit package 300b according to another embodiment of the present invention is a package which can be electrically connected to electrode terminals 410 and 430 of a battery bare cell 400 and includes a substrate 50 and 60 on which a conductive line pattern 246 is formed, battery protection circuit elements which are mounted on the substrate 50 and 60 and which includes a protection IC 120, a field effect transistor (FET) 110, and at least one passive element 130, and an NFC antenna structure 140 which is mounted on the substrate 50 and 60. The conductive line pattern 246 may form at least part of an extension antenna which is connected to the NFC antenna structure 140 to form a loop.

Here, the substrate 50 and 60 includes a lead frame 50 including plural leads 50-1, 50-2, 50-3, 50-4, 50-5, 50-6, and 50-7 and a printed circuit board 60 disposed on the lead frame 50.

The lead frame 50 includes a first internal connection terminal lead 50-1 and a second internal connection terminal lead 50-7 which are disposed on both edges and which are electrically connected to the electrode terminals of the battery bare cell, external connection terminal leads 50-2, 50-3, 50-4, and 50-5 which are disposed between the first internal connection terminal lead 50-1 and the second internal connection terminal lead 50-7 and which constitute plural external connection terminals, and a dummy lead 50-6 which is disposed between the first internal connection terminal lead 50-1 and the second internal connection terminal lead 50-7 and which constitutes part of the loop. In this case, the external connection terminals of the battery protection circuit package 300b illustrated in FIGS. 5 and 6B can be understood to be the external connection terminal leads 50-2, 50-3, 50-4, and 50-5. The dummy lead 50-6 is configured to form part of a loop and the battery protection circuit elements 110, 120, and 130 are not mounted on the dummy lead 50-6.

The printed circuit board 60 may be disposed on the external connection terminal leads 50-2, 50-3, 50-4, and 50-5 so as not to overlap the dummy lead 50-6.

The conductive line pattern 246 may be, for example, a pattern which surrounds the edge of the printed circuit board 60. The conductive line pattern 246 is a pattern formed on the printed circuit board 60, and is not a wiring pattern for electrical connection of the protection IC 120, the field effect transistor (FET) 110, and at least one passive element 130, but may be a pattern which is formed particularly formed to constitute at least a part of the first inductor 146 illustrated in FIG. 1B.

The conductive line pattern 246 may include, for example, a first conductive line pattern 246-1 and a second conductive line pattern 246-2 which are separated from each other. An end of the first conductive line pattern 246-1 may be connected to a first mounting pad 52-4 formed on the printed circuit board 60 and the other end of the first conductive line pattern 246-1 may be connected to a bonding pad 244 formed on the printed circuit board 60. An end of the second conductive line pattern 246-2 may be connected to a second mounting pad 52-5 formed on the printed circuit board 60 and the other end of the second conductive line pattern 246-2 may be connected to a bonding pad 244 formed on the printed circuit board 60. The NFC antenna structure 140 are mounted on the first mounting pad 52-4 and the second mounting pad 52-5 which are formed on the printed circuit board. The NFC antenna structure 140 is the same as described above with reference to FIG. 7 and thus will not be repeatedly described.

On the other hand, the bonding pads 244 are electrically connected to the dummy lead 50-6 by electrical connection members 244. The electrical connection members 244 may include, for example, a bonding wire. Accordingly, both ends of the conductive line pattern 246 and both ends of the dummy lead 50-6 are connected by the electrical connection members 244 to form an antenna loop.

Since the NFC antenna structure 140 illustrated in FIG. 8C has a size smaller than the NFC antenna 470 illustrated in FIG. 4, the antenna strength may be relatively small. The conductive line pattern 246, the electrical connection members 244, and the dummy lead 50-6 which are connected to the NFC antenna structure 140 to form a loop so as to compensate for the strength may be understood to be an extension antenna or an auxiliary antenna of the NFC antenna structure 140.

As described above with reference to Table 1, it can be seen that when the ratio of the inductance value generated in the conductive line pattern 246 and the inductance value generated in the NFC antenna structure 140 is equal to or greater than a predetermined ratio (for example, 13%) by guaranteeing the length of the extension antenna to be equal to or greater than a predetermined length, improvement in NFC recognition distance can be observed due to introduction of the extension antenna. In FIGS. 8A to 8C, the length of the extension antenna which is introduced for improvement in NFC recognition distance corresponds to the total sum of the length of the conductive line pattern 246, the lengths of the electrical connection members 244, and the length of the dummy lead 50-6.

In the above-mentioned embodiments, the NFC antenna structure 140 is incorporated into the battery protection circuit package 300b, and the conductive line pattern 246 is connected to the NFC antenna structure 140 and thus can be understood to be the extension antenna or the auxiliary antenna of the NFC antenna structure 140.

In a modified example of the present invention, the NFC antenna structure 140 is not incorporated into the battery protection circuit package 300b but may be mounted on a predetermined component disposed outside the battery protection circuit package 300b. In this case, the conductive line pattern 246 constituting the battery protection circuit package 300b can be connected to the NFC antenna structure 140 via an additional connection pattern to serve as the extension antenna or the auxiliary antenna of the NFC antenna structure 140. In another modified example of the present invention, an NFC antenna may be constituted by only the conductive line pattern 246 instead of introducing the NFC antenna structure 140.

On the other hand, in the drawings illustrating the embodiments of the present invention, the sealing member 250 is illustrated as a single sealing member. However, in a modified example, plural sealing members which seal at least two selected from at least part of the substrate 50 and 60, the battery protection circuit elements 110, 120, and 130, the NFC antenna structure 140, and the conductive line pattern 246 and which are separated from each other may be employed.

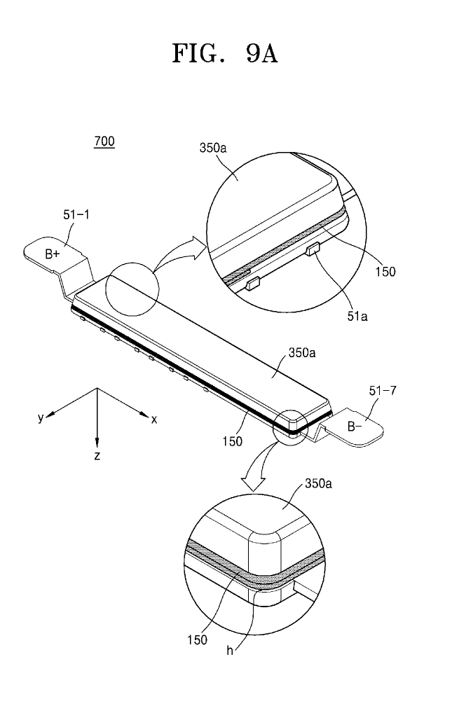

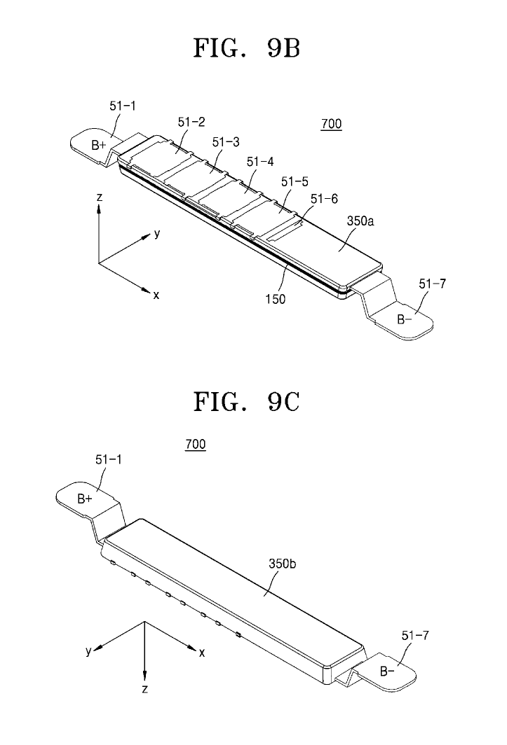

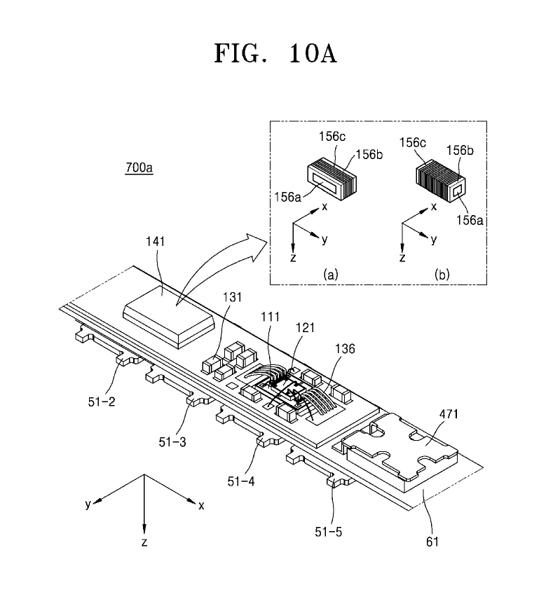

FIGS. 9A to 9C are perspective views schematically illustrating a configuration of an NFC antenna which is formed in a battery protection circuit package according to still another embodiment of the present invention.

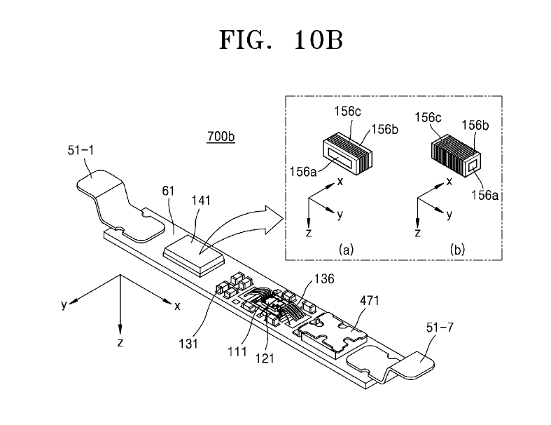

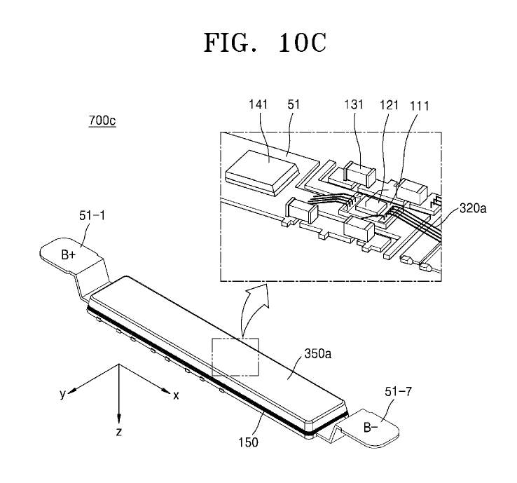

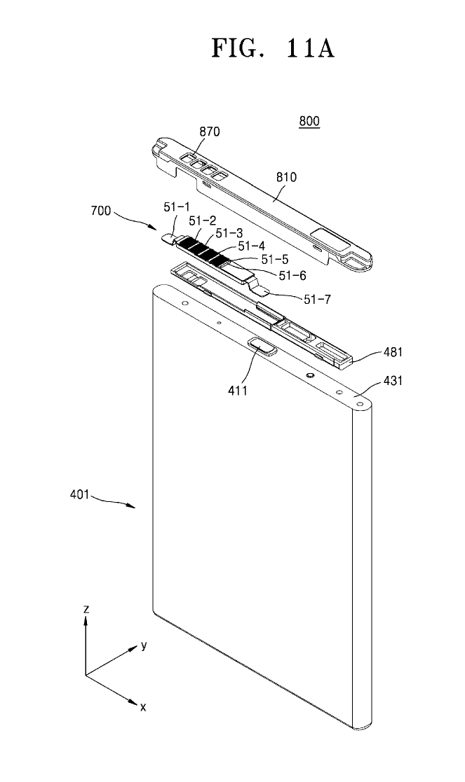

Referring to FIGS. 9A and 9B, A battery protection circuit package 700 is a package which can be electrically connected to electrode terminals of a battery bare cell and includes battery protection circuit elements which are mounted on a substrate and which include a protection IC, a field effect transistor (FET), and at least one passive element, a first sealing member 350a which is formed on the substrate, and an NFC antenna 150 which surrounds at least part of the outer circumferential surface of the first sealing member 350a. The NFC antenna 150 serves as a main antenna and corresponds to at least a part of the first inductor 146 illustrated in FIG. 1B. Here, detailed configurations of the substrate, the protection IC, the field effect transistor (FET), the passive element, and the battery bare cell will be described later with reference to FIGS. 10A to 10C.

The first sealing member 350a may seal at least part of the substrate and at least one element selected from the battery protection circuit elements. For example, the battery protection circuit elements including the protection IC, the field effect transistor (FET), and at least one passive element can be sealed with the first sealing member 350a. In a modified example, the NFC antenna 150 may be formed using a dummy part which is formed by sealing at least part of the substrate so as to serve as an extension antenna in addition to the battery protection circuit elements. The dummy part is a dummy sealing member which does not sealing the battery protection circuit elements and can be used to only form the NFC antenna 150.

A groove h may be formed in at least part of the outer circumferential surface of the first sealing member 350a, and at least part of the NFC antenna 150 may be disposed in the groove h. Referring to FIG. 9a, in the battery protection circuit package 700 according to the embodiment of the present invention, the groove h is formed by performing an etching process on at least one side surface of the first sealing member 350a so as to mount part of a coil or a wire on the battery protection circuit package 700. Alternatively, the groove h may be formed using a molding process with a mold without using the etching process.

On the other hand, the NFC antenna 150 may be formed by winding a wire along the groove h. Here, when the groove h is used as only a guide for disposing the NFC antenna 150, at least part of the NFC antenna 150 may be disposed in the groove h. For example, only part of the NFC antenna 150 is disposed in the groove h and the other part may be disposed to protrude outward while surrounding the outer circumferential surface of the first sealing member 350a of the battery protection circuit package 700. When the groove h is formed by performing the etching process so as to slightly wind a wire in the groove h as described above, it is possible to shorten an etching process time.

In a battery protection circuit package 700 according to still another embodiment of the present invention, the whole NFC antenna 150 may be disposed in the groove h. In this case, since the wire is disposed in the battery protection circuit package 700 and does not protrude outward, this structure is advantageous in terms of structural stability.

The NFC antenna 150 may surround at least part of the outer circumferential surface of the first sealing member 350a by one or more turns. In FIG. 9A, a wire is wound by two turns and both ends of the NFC antenna 150 can be connected to predetermined connecting terminals in the battery protection circuit package 700 via a portion 51a that is not sealed with the first sealing member 350a among plural leads of the battery protection circuit package 700. That is, on the bottom surface of the battery protection circuit package 700 illustrated in FIG. 9B, external connection terminals 51-2, 51-3, 51-4, and 51-5 are exposed from the first sealing member 350a, and both ends of the NFC antenna 150 can be electrically connected via the part 51a protruding from both ends of the external connection terminals. In this case, the NFC antenna 150 can serve as a main antenna for NFC communication.

In a battery protection circuit package 700 according to a modified example of the present invention, a first groove and a second groove which are connected to each other may be formed on the outer circumferential surface of the first sealing member 350a of the battery protection circuit package 700, one end of the NFC antenna 150 may be disposed in the first groove, and the other end of the NFC antenna 150 may be disposed in the second groove. For example, out of the first groove and the second groove in which a wire serving as an antenna are connected to each other on the outer circumferential surface of the first sealing member 350a, one end and the other end of the wire may be disposed in the first groove and the second groove, respectively, in a spring shape and may be connected to a predetermined connection terminal in the battery protection circuit package 700, thereby constituting part of the NFC antenna 150 forming a loop. Here, the loop has an arbitrary shape which can generate inductance. The loop is not limited to a closed loop.

The NFC antenna 150 may be constituted using a conductive paste screening method or a stamp method other than the method using a wire. For example, the NFC antenna 150 may be formed using a screen printing method using a conductive paste or using a stamp method instead of the method of winding a wire on at least one side surface of the first sealing member 350a of the battery protection circuit package 700.

As the NFC antenna 150, a pattern structure having a loop shape may be formed on the top and/or bottom surface of the first sealing member 350a. For example, the NFC antenna 150 enabling performing NFC communication may be formed by forming a pattern having a loop shape on the top surface of the battery protection circuit package 700, that is, the top surface sealed with the first sealing member 350a, and then disposing a wire in the pattern. Alternatively, a closed loop may be formed to have a loop shape using the screen printing method using a conductive paste.

In the battery protection circuit package 700 illustrated in FIG. 9C, a second sealing member 350b is formed in the configurations illustrated in FIGS. 9A and 9B. For example, the battery protection circuit package 700 may further include the second sealing member 350b which seals the NFC antenna 150 surrounding at least part of the outer circumferential surface of the first sealing member 350a and a portion 51a not sealed with the first sealing member 350a. In this case, the exposed parts can be safely protected by sealing both the NFC antenna 150 exposed from the battery protection circuit package 700 and the exposed part 51a. Since the NFC antenna 150 is formed using a partial space of the battery protection circuit package 700, this configuration is advantageous for integration and miniaturization.

On the other hand, the battery protection circuit package 700 may further include a second sealing member 350b which seals only the NFC antenna 150 surrounding at least part of the outer circumferential surface of the first sealing member 350a. For example, the second sealing member 350b may seal only the NFC antenna 150 disposed in the groove h of the battery protection circuit package 700 illustrated in FIG. 9A. In this case, by sealing only the protruding part of the NFC antenna 150 with the second sealing member 350b instead of sealing the whole side surface of the battery protection circuit package 700, it is possible to shorten the process time and to reduce material costs.

When an antenna structure is disposed in the battery protection circuit package 700, the NFC antenna 150 illustrated in FIGS. 9A and 9B may serve as an auxiliary antenna or an extension antenna for NFC communication. In this case, the recognition range of the antenna can be enhanced by increasing the area of the antenna, thereby improving performance of the antenna. Details of the antenna structure will be described later with reference to (a) and (b) of FIGS. 10A and 10B.

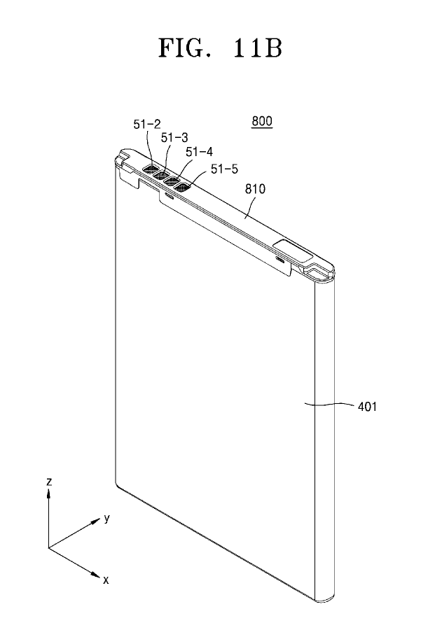

FIGS. 10A to 10C are perspective views illustrating a partial configuration of a battery protection circuit package according to still another embodiment of the present invention. FIGS. 11A and 11B are perspective views schematically illustrating a configuration of a battery pack including a battery protection circuit package according to still another embodiment of the present invention. A partial configuration of the battery protection circuit package which is not sealed with a sealing member will be described. FIGS. 10A to 10C are similar to each other in types of parts constituting the battery protection circuit package and are different from each other in types of substrates.

Referring to FIGS. 10A, 11A, and 11B, reference numeral 700a in FIG. 10A denotes a partial configuration of a battery protection circuit package according to an embodiment, and the battery protection circuit package 700a can be disposed on one side of a top surface 431 with respect to a negative electrode terminal 411 of a battery bare cell 401. In some cases, the battery protection circuit package 700 may be disposed on the whole top surface of the battery bare cell 401.

On the other hand, a battery pack 800 includes a holder 481 interposed between the top surface of the battery bare cell 401 and the battery protection circuit package 700. The holder 481 may be formed to be bonded to the battery protection circuit package 700 by disposing at least a part of the battery protection circuit package 700 in a first injection mold and injecting a resin melt therein to perform injection molding.

An upper case 810 includes through-holes 870 for exposing the external connection terminals 51-2, 51-3, 51-4, and 51-5 of the battery protection circuit package 700, and may be formed to be bonded to at least one selected from the battery bare cell 401 and the battery protection circuit package 700 by disposing at least a part of the battery protection circuit package 700 disposed on the top surface of the battery bare cell 401 in a second injection mold and injecting a resin melt therein to perform injection molding.

The battery protection circuit package 700 includes a substrate 51 and a protection IC 121, a field effect transistor 111, and at least one passive element 131 which are mounted on the substrate 51 and further includes a first sealing member 350a which seals the protection IC 1221, the field effect transistor 111, and at least one passive element 131.

On the other hand, the substrate 51 and 61 includes a lead frame and a printed circuit board, and the printed circuit board (PCB) 61 is formed on the lead frame substrate 51. An antenna structure 141 for NFC communication which is amounted on the printed circuit board 61 and which is sealed with the first sealing member 350a may be further provided. The NFC antenna 150 illustrated in FIGS. 9A and 9B may be connected to the antenna structure 141. In this case, the NFC antenna 150 can serve as an auxiliary antenna or an extension antenna for NFC communication. The antenna structure 141 may have the form of a chip. The lead frame substrate 51 is a lead frame 51 including plural leads which includes a first internal connection terminal lead 51-1 and a second internal connection terminal lead 51-7 which are disposed on both edges and which are electrically connected to electrode terminals 411 and 431 of the battery bare cell 401 and external connection terminal leads which are disposed between the first internal connection terminal lead 51-1 and the second internal connection terminal lead 51-7 and which constitute plural external connection terminals 51-2, 51-3, 51-4, and 51-5, and includes electrical connection members which electrically connect two elements selected from a group consisting of the antenna structure 141, the protection IC 121, the field effect transistor 111, and plural leads, thereby constituting a battery protection circuit. The NFC antenna 150 and the antenna structure 141 can be connected to each other via a portion, which is not sealed by the first sealing member 350a, of the leads.

On the other hand, the antenna structure 141 may serve as a main antenna and the NFC antenna 150 formed on the outer circumferential surface of the first sealing member 350a of the battery protection circuit package 700a may serve as an auxiliary antenna. On the contrary, when the antenna structure 141 is excluded, the NFC antenna 150 may serve as the main antenna. When the antenna structure 141 serves as the main antenna, the antenna area is greater than that when the NFC antenna 150 serves as the main antenna and thus the recognition range of the antenna is wider, thereby improving the antenna performance.

The NFC antenna 150 illustrated in FIGS. 9A and 9B may have a shape which can generate inductance and may have, for example, a shape of at least part of a loop which can generate inductance. Inductance is a quantity indicating a ratio of a counter-electromotive force generated by electromagnetic induction due to a variation in a current flowing in a circuit and the unit thereof is H (Henry).

The inventor of the present invention found that the inductance value generated in the NFC antenna 150 should be greater by a predetermined proportion than the inductance value generated in the antenna structure 141 in order for the NFC antenna 150 not to merely be a conductive pattern but to actually serve as an auxiliary antenna.

Table 2 describes results of experiments for checking whether the NFC antenna 150 serve as an NFC auxiliary antenna depending on the inductance value generated in the NFC antenna 150 when the inductance value generated in the antenna structure 141 is 0.56 μH.

TABLE 2

| | Inductance value | Length of | | |
|---|---|---|---|---|
| | of extension | extension | | Serving as |
| Experimental | antenna | antenna | Inductance | NFC auxiliary |
| Example | (μH) | (mm) | ratio | antenna |
| Ex. 6 | 0.04 | 34 | 6% | x |
| Ex. 7 | 0.05 | 37 | 8% | x |
| Ex. 8 | 0.07 | 43 | 11% | x |
| Ex. 9 | 0.08 | 47 | 13% | ∘ |
| Ex. 10 | 0.09 | 50 | 14% | ∘ |

In Experimental Example 6, when the length of the NFC antenna 150 forming a loop was 34 mm, the inductance value generated in the NFC antenna 150 was 0.04 μH and the NFC antenna 150 did not serve as the NFC auxiliary antenna. That is, when the inductance value generated in the NFC antenna 150 was 6% of the inductance value generated in the antenna structure 141, improvement in NFC recognition distance was not observed in spite of introduction of the extension antenna including the NFC antenna 150.

On the contrary, in Experimental Example 9, when the length of the NFC antenna 150 forming a loop was 47 mm, the inductance value generated in the NFC antenna 150 was 0.08 μH and the NFC antenna 150 served as the NFC auxiliary antenna. That is, when the inductance value generated in the NFC antenna 150 was 13% of the inductance value generated in the antenna structure 141, improvement in NFC recognition distance was observed due to the introduction of the extension antenna including the NFC antenna 150.

Referring to Experimental Examples 6 to 10, it can be seen that when the ratio of the inductance value generated in the NFC antenna 150 and the inductance value generated in the antenna structure 141 is equal to or greater than a predetermined ratio (for example, 13%) by guaranteeing the length of the antenna structure 141 constituting the extension antenna to be equal to or greater than a predetermined length, improvement in NFC recognition distance can be observed due to introduction of the extension antenna including the antenna structure 141.

As described above with reference to FIG. 9C, the second sealing member 350b which seals the NFC antenna 150 surrounding at least part of the outer circumferential surface of the first sealing member 350a and at least a portion 51a not sealed by the first sealing member 350a may be further provided.

On the other hand, a PTC element 471 illustrated in FIG. 10A is not essential to the battery protection circuit package 700, and may be independently disposed outside the battery protection circuit package 700 or may be disposed in the form of a chip inside the battery protection circuit package 700. The PTC element 471 can be formed, for example, by dispersing conductive particles in crystalline polymer. Accordingly, the PTC element 471 serves as a passage in which a current flowing at a predetermined temperature or lower. However, when the temperature is higher than the predetermined temperature due to occurrence of an overcurrent, the crystalline polymer expands, the conductive particles dispersed in the crystalline polymer is separated from each other, and thus resistance rapidly increases. Accordingly, a current flow in the battery bare cell is cut off or reduced. Since the current flow can be cut off by the PTC element 471 in this way, the PTC element 471 serves as a safety for preventing destruction of the battery. When the temperature becomes equal to or lower than the predetermined temperature, the crystalline polymer of the PTC element 471 contracts, the bonding between the conductive particles is restored, and a current flows smoothly. Other elements in addition to the PTC element 471 may be incorporated into the substrate in the form of a chip.

On the other hand, in a partial configuration of a battery protection circuit package according to still another embodiment of the present invention, the printed circuit board 61 may be used as a substrate on which the battery protection circuit elements and the antenna structure 141 can be mounted. Detailed description thereof will be made later with reference to FIG. 10B.

A principal technical idea of the present invention is that the battery protection circuit package 700 includes at least one antenna structure 141 performing an NFC function. The antenna structure 141 will be described in detail below.

The antenna structure 141 constituting the battery protection circuit package 700 according to some embodiments of the present invention may have, for example, the form of a chip illustrated in (a) and (b) of FIG. 10A.

The antenna structure 141 constituting the battery protection circuit package 700 according to some embodiments of the present invention may include an inductor which can resonate in an NFC frequency region. The inductor of the antenna structure 141 corresponds to at least a part of the first inductor illustrated in FIG. 1B and can be replaced for the NFC antenna 470 constituting the battery protection circuit package 300 according to the comparative example of the present invention illustrated in FIG. 2.

The antenna structure 141 constituting the battery protection circuit package according to some embodiments of the present invention may further include at least one selected from the first capacitor unit 145, the second capacitor unit 143, and the NFC control IC circuit unit 142 which are illustrated in FIG. 1B.

In the battery protection circuit package according to some embodiments of the present invention, since the terminal pads 472 and 474 for the antenna soldering process are not necessary, it is possible to decrease the size of the package and to guarantee the internal space of the package. It is possible to exclude the antenna soldering process and thus to simplify the process of manufacturing a battery pack 800. In addition, it is possible to improve shearing strength in terms of the whole structure by mounting and sealing the antenna structure 141 in the form of a chip in the battery protection circuit package 700 without disposing and bonding a film-shaped NFC antenna 470 illustrated in FIG. 2 outside the battery protection circuit package.

On the other hand, referring to (a) and (b) of FIG. 10A and FIG. 11A, the antenna structure 141 including the inductor which can resonate in the NFC frequency region may have various winding structure.

First, a winding structure illustrated in (a) of FIG. 10 includes a coil having a first winding direction. For example, the winding structure includes a core 156a formed of a nickel-ferrite material and a coil 156c having the first winding direction and being wound in a direction parallel to an x axis direction and a z axis direction so as to surround a bobbin 156b. In this case, a direction of an induced magnetic field generated in cooperation with the NFC reader 148 is parallel to a y axis direction. That is, when the side surfaces of the battery bare cell 401 include a large-width surface (surface perpendicular to they axis) and a small-width surface (surface perpendicular to the x axis), the direction of the magnetic field induced in the antenna structure 141 including the inductor may be perpendicular to the large-width surface of the battery bare cell 401. In this winding structure, near field communication can be realized when the NFC reader and the large-width surface of the battery bare cell 401 are located to be parallel to each other.

Second, in the battery protection circuit package 700, plural antenna structures 141 having a winding structure illustrated in (b) of FIG. 10A may be arranged to be separated from each other. When the antenna structure 141 has the form of a chip, the battery protection circuit package 700 may include plural chips including an NFC antenna. Each winding structure is the same as described in the first example. That is, each antenna structure 141 includes a coil 156c having the first winding direction as illustrated in (a) of FIG. 10A, and the direction of the magnetic field induced in the antenna structures 141 may be perpendicular to a large-width surface of the battery bare cell 401 when the side surfaces of the battery bare cell 401 include a large-width surface (surface perpendicular to they axis) and a small-width surface (surface perpendicular to the x axis). On the other hand, in a modified example, when the antenna structure 141 has the form of a chip, the battery protection circuit package 700 may include a single chip including an NFC antenna and plural winding structures illustrated in (b) of FIG. 10A may be disposed in the single chip. In this winding structure, near field communication can be realized when the NFC reader and the large-width surface of the battery bare cell 401 are located to be parallel to each other. It can be expected to improve sensitivity of near field communication in comparison with the antenna structure 141 of the first example.

Third, the battery protection circuit package 700 includes plural antenna structures 141 which are separated from each other, and some antenna structures of the plural antenna structures 141 include the coil 156c having the first winding direction as illustrated in (a) of FIG. 10A and the other antenna structures include a coil 156c having a second winding direction which is perpendicular to the first winding direction as illustrated in (b) of FIG. 10A. For example, the winding structure having the first winding direction includes a core 156a formed of a nickel-ferrite material and a coil 156c wound in a direction parallel to the x axis direction and the z axis direction so as to surround a bobbin 156b. The winding structure having the second winding direction includes a core 156a formed of a nickel-ferrite material and a coil 156c wound in a direction parallel to they axis direction and the z axis direction so as to surround a bobbin 156b. When the side surfaces of the battery bare cell 401 include the large-width surface (surface perpendicular to they axis) and the small-width surface (surface perpendicular to the x axis), the direction of a magnetic field induced in the coil having the first winding direction may be perpendicular to the large-width surface of the battery bare cell 401 and the direction of a magnetic field induced in the coil having the second winding direction may be perpendicular to the small-width surface of the battery bare cell 401.

When the antenna structure 141 has the form of a chip, the battery protection circuit package 700 may include a first antenna structure in the form of a chip having the winding structure of the first winding direction and a second antenna structure in the form of a chip having the winding structure of the second winding direction. In another example, the battery protection circuit package 700 may include a winding structure including the coil 156c having the first winding direction and the winding structure including the coil 156c having the second winding direction in a single chip including the antenna structure 141. In this winding structure, even when the NFC reader and the large-width surface of the battery bare cell 401 are not located to be relatively parallel to each other but form an arbitrary angle, near field communication can be realized. It can be expected to improve sensitivity of near field communication.

On the other hand, the winding structure constituting the antenna structure 141 is described to be a winding structure in which a coil is wound on a core. However, the antenna structure 141 according to the technical idea of the present invention is not limited to this winding structure and may be embodied, for example, by patterning a conductive material.

Referring to FIGS. 10A, 11A, and 11B, reference numeral 700b in FIG. 10B denotes a partial configuration of a battery protection circuit package 700 according to another embodiment, which is a package electrically connected to electrode terminals 411 and 431 of the battery bare cell 401, and includes an antenna structure 141 which is mounted on a printed circuit board 61 and which performs as an NFC function and battery protection circuit elements. The battery protection circuit elements are disposed on the printed circuit board 61 and include a protection IC 121, a field effect transistor 111, and at least one passive element 131. Here, the antenna structure 141 and the battery protection circuit elements can be mounted on the printed circuit board 61. The partial configuration of the battery protection circuit package according to an embodiment of the present invention may further include a first sealing member 350a if necessary. The first sealing member 350a can seal at least one selected from the battery protection circuit elements and the antenna structure 141. For example, the first sealing member 350a can seal the battery protection circuit elements and the antenna structure 141 together. In another example, the first sealing member 350a may be discretely disposed to respectively seal the battery protection circuit elements and the antenna structure 141. Here, details of the structure and function of the antenna structure 141 are the same as described above with reference to FIG. 10A and will not be described.

Referring to FIGS. 10C, 11A, and 11B, a partial configuration of a battery protection circuit package 700c according to still another embodiment is as follows. The battery protection circuit package 700c is a package which can be electrically connected to the electrode terminals of the battery bare cell 401 and includes battery protection circuit elements which are mounted on the lead frame substrate 51 and which include a protection IC 121, a field effect transistor (FET) 111, and at least one passive element 130.

The lead frame substrate 51 is a lead frame 51 including plural leads which includes a first internal connection terminal lead 51-1 and a second internal connection terminal lead 51-7 which are disposed on both edges and which are electrically connected to electrode terminals 411 and 431 of the battery bare cell 401 and external connection terminal leads which are disposed between the first internal connection terminal lead 51-1 and the second internal connection terminal lead 51-7 and which constitute plural external connection terminals 51-2, 51-3, 51-4, and 51-5, and includes the antenna structure 141 for NFC communication. Here, the structure and function of the antenna structure 141 are the same as described above with reference to FIG. 10A and will not be described. Since electrical connection members 320a which electrically connect two elements selected from a group consisting of the antenna structure 141, the protection IC 121, the field effect transistor 111, and plural leads, it is possible to constitute a battery protection circuit without using a particular printed circuit board.

In other words, the substrate on which the battery protection circuit elements 111, 121, and 131 and the antenna structure 141 are mounted in the battery protection circuit package 700c may include only the lead frame 51. In this case, the battery protection circuit elements 111, 121, and 131 and the antenna structure 141 can be mounted on at least part of the surface of the lead frame 51 using a surface mounting technique. In addition, since electrical connection members 320a which electrically connect two elements selected from a group consisting of the antenna structure 141, the protection IC 121, the field effect transistor 111, and plural leads, it is possible to constitute a battery protection circuit without using a particular printed circuit board. The electrical connecting member may include a bonding wire or a bonding ribbon.

Since the electrical connection members such as bonding wires or bonding ribbons are disposed on the lead frame 51 to construct a circuit, the procedure of designing and manufacturing the lead frame 51 for constructing a battery protection circuit can be simplified. In a modified example of the present invention, when the electrical connection members are not introduced into the battery protection circuit, the configuration of plural leads constituting the lead frame 51 is very complicated and thus it may not be easy to provide an appropriate lead frame 51.

In embodiments in which the substrate includes only the lead frame 51, the antenna structure 141, the protection IC 121 and/or the field effect transistor 111 are not mounted and fixed in the form of a semiconductor package onto the lead frame 51, but may be mounted and fixed thereon in the form of a chip die, which is obtained by sawing a wafer not sealed with a particular first sealing member 350a, on at least part of the surface of the lead frame substrate 51 using a surface mounting technique. Here, a chip die means an individual structure which is obtained by sawing a wafer on which plural structures (for example, a protection IC and a field effect transistor) of an array type are formed without being sealed with a particular first sealing member 350a. That is, when the antenna structure 141, the protection IC 121 and/or the field effect transistor 111 are mounted on the lead frame substrate 51, the antenna structure 141, the protection IC 121 and/or the field effect transistor 111 are mounted in a state where they are not sealed with a particular sealing member and then are sealed with the first sealing member 350a. Accordingly, the process of forming the first sealing member is carried out only once in constructing the battery protection circuit package 700c. On the contrary, when the passive element 131, the antenna structure 141, the protection IC 121 and/or the field effect transistor 111 are mounted and fixed onto the printed circuit board 60 as in the battery protection circuit package illustrated in FIG. 10B, a molding process should be first performed once for the respective components and another molding process should be performed on the respective mounted components after the components are mounted and fixed onto the printed circuit board 61, thereby complicating the manufacturing process and increasing the manufacturing cost.

As described above, when a battery pack is manufactured using the battery protection circuit package according to the related art, an existing RF antenna is used and thus the mounting position is very restrictive due to the size of the antenna. When a battery pack is manufactured using a metal body, there is a problem in that the antenna performance is lowered. When an NFC chip antenna is used, there is problem in that since the size of the antenna is small and the recognition range is limited due to the size of the NFC chip antenna, the antenna performance is lowered.

In order to solve these problems, in the battery protection circuit package according to the embodiments of the present invention, a mounting space for mounting a coil is formed on the side surface of the battery protection circuit package according to the related art. The coil is disposed in the formed space to surround the side surface of the battery protection circuit package, and both ends of the coil can be electrically connected using tie bars protruding from both sides of the CD terminal 51-3 and the NFC antenna terminal 51-5 among the external connection terminals 51-2, 51-3, 51-4, and 51-5 of the battery protection circuit package illustrated in FIG. 9B.

On the other hand, in order to protect the coil formed on the side surface of the battery protection circuit package and the exposed tie bars, secondary molding may be performed using a sealing member to finish the package. An NFC chip antenna or an inductor can be additionally formed in the battery protection circuit package. In this case, the antenna formed on the side surface of the battery protection circuit package serves as an extension antenna, and the NFC chip antenna or the inductor formed in the battery protection circuit package serves as a main antenna for NFC communication.

Since integration and miniaturization are possible by using the space of the battery protection circuit package used for protecting the secondary battery as a space for an NFC antenna and the recognition range and distance of the antenna can be increased by increasing the area of the NFC antenna, it is possible to provide a battery protection circuit package with improved antenna performance.

While the present invention has been described with reference to the embodiments illustrated in the drawings, the embodiments are merely illustrative, and it will be understood by those skilled in the art that the present invention can be modified in various forms. Therefore, the technical scope of the present invention will be determined based on the technical idea of the appended claims.

What is claimed is:

1. A battery protection circuit package that is electrically connected to electrode terminals of a battery bare cell, the battery protection circuit package comprising:
a substrate on which a conductive line pattern is disposed;
a battery protection circuit element that is mounted on the substrate and includes a protection IC, a field effect transistor (FET), and at least one passive element; and
an NFC antenna structure that is mounted on the substrate,
wherein the conductive line pattern constitutes at least part of an extension antenna that is connected to the NFC antenna structure to form a loop.

2. The battery protection circuit package according to claim 1, wherein the NFC antenna structure has a form of a chip.

3. The battery protection circuit package according to claim 1, wherein the substrate includes a printed circuit board (PCB),
wherein the conductive line pattern is a pattern on the printed circuit board and both ends of the conductive line pattern are respectively connected to the NFC antenna structure, and
wherein the extension antenna includes only the conductive line pattern.

4. The battery protection circuit package according to claim 3, wherein the conductive line pattern surrounds an edge of the printed circuit board.

5. The battery protection circuit package according to claim 1, wherein the substrate includes a lead frame including a plurality of leads and a printed circuit board (PCB) disposed on the lead frame,
wherein the lead frame includes a first internal connection terminal lead and a second internal connection terminal lead that are disposed on both edges of the lead frame, respectively, and are electrically connected to electrode terminals of the battery bare cell; an external connection terminal lead that is disposed between the first internal connection terminal lead and the second internal connection terminal lead and constitutes a plurality of external connection terminals; and a dummy lead that is disposed between the first internal connection terminal lead and the second internal connection terminal lead and constitutes part of the loop,
wherein the conductive line pattern is disposed on the printed circuit board, and
wherein both ends of the conductive line pattern and both ends of the dummy lead are connected to each other via an electrical connection member and the extension antenna includes the conductive line pattern, the dummy lead, and the electrical connection member.

6. The battery protection circuit package according to claim 5, wherein the printed circuit board is disposed on the external connection terminal lead so as not to overlap the dummy lead.

7. The battery protection circuit package according to claim 1, further comprising a sealing member that seals at least one selected from a group consisting of at least part of the substrate, the battery protection circuit element, the NFC antenna structure, and the conductive line pattern.

8. The battery protection circuit package according to claim 1, wherein the length of the extension antenna is set such that a ratio of an inductance value generated in the extension antenna and an inductance value generated in the NFC antenna structure is equal to or greater than 13%.

9. A battery protection circuit package that is electrically connected to electrode terminals of a battery bare cell, the battery protection circuit package comprising:
a substrate;
a battery protection circuit element that is mounted on the substrate and includes a protection IC, a field effect transistor (FET), and at least one passive element;
a first sealing member that is disposed on the substrate; and
an NFC antenna that surrounds at least part of the outer circumferential surface of the first sealing member.

10. The battery protection circuit package according to claim 9, wherein at least part of the NFC antenna is disposed in a groove in at least part of the outer circumferential surface of the first sealing member.

11. The battery protection circuit package according to claim 9, wherein the NFC antenna surrounds the outer circumferential surface of the first sealing member by one or more turns.

12. The battery protection circuit package according to claim 9, further comprising an antenna structure that is mounted on the substrate, sealed by the first sealing member and used for NFC communication,
wherein the NFC antenna is connected to the antenna structure.

13. The battery protection circuit package according to claim 12, wherein the antenna structure has a form of a chip.

14. The battery protection circuit package according to claim 12, wherein the substrate is a lead frame including a plurality of leads, and the plurality of leads include a first internal connection terminal lead and a second internal connection terminal lead that are disposed on both edges of the lead frame, respectively, and are electrically connected to electrode terminals of the battery bare cell; and an external connection terminal lead that is disposed between the first internal connection terminal lead and the second internal connection terminal lead and constitutes a plurality of external connection terminals, and
wherein a battery protection circuit is constituted without using a printed circuit board by being provided with an electrical connection member that electrically connects two selected from a group consisting of the antenna structure, the protection IC, the field effect transistor, and the plurality of leads.

15. The battery protection circuit package according to claim 14, wherein the NFC antenna and the antenna structure are connected to each other via part of a portions that are not sealed by the first sealing member among the plurality of leads.

16. The battery protection circuit package according to claim 12, wherein the length of the NFC antenna is set such that a ratio of an inductance value generated in the NFC antenna and an inductance value generated in the antenna structure is equal to or greater than 13%.

17. The battery protection circuit package according to claim 9, further comprising a second sealing member that seals the NFC antenna surrounding at least part of the outer circumferential surface of the first sealing member.

18. The battery protection circuit package according to claim 9, wherein the first sealing member seals at least part of the substrate and/or the battery protection circuit element.
